(19) United States
(12) Patent Application Publication
(10) Pub. No.: US 2026/0172071 A1
(43) Pub. Date: Jun. 18, 2026

(54) RADIO COMMUNICATION TRANSCEIVER

(71) Applicant: NTT, Inc., Tokyo (JP)

(72) Inventors: Teruo Jo, Tokyo (JP); Daisuke Kitayama, Tokyo (JP); Hiroyuki Takahashi, Tokyo (JP)

(21) Appl. No.: 19/127,271

(22) PCT Filed: Nov. 7, 2022
(86) PCT No.: PCT/JP2022/041329

§ 371 Date: May 5, 2025

(51) Int. Cl. H04B 1/525; H04B 1/00; H04B 1/10; H04B 1/30; H04B 1/403

(52) U.S. Cl. CPC H04B 1/525; H04B 1/0057; H04B 1/109; H04B 1/30; H04B 1/406

(57) ABSTRACT

An embodiment is a radio communication transceiver including a first frequency multiplier configured to multiply a frequency of a local oscillator (LO) signal, a mixer configured to mix the LO signal and an intermediate frequency (IF) signal output from the first frequency multiplier to generate a radio frequency (RF) signal, a cancel signal generator configured to generate a cancel signal to cancel LO leakage generated in the mixer, an antenna configured to transmit an RF signal, and a multiplexer configured to output a signal obtained by adding the output signal of the mixer and the cancel signal to the antenna, where the cancel signal generator generates the cancel signal having a same absolute value of strength and an opposite phase at a same frequency with respect to the LO leakage generated in the mixer and input to the multiplexer.

### CROSS-REFERENCE TO RELATED APPLICATIONS

This application is a national phase entry of PCT Application No. PCT/JP2022/041329, filed on Nov. 7, 2022, which application is hereby incorporated herein by reference.

### TECHNICAL FIELD

The present disclosure relates to a radio communication transceiver.

### BACKGROUND

With continuous increase in content capacity, in recent years, high-speed radio communication by a broadband transceiver in the terahertz band is expected. Among radio communication transceivers, a mixer is an important circuit that plays a role of frequency conversion, and is required to operate in a terahertz band and have a wide band. Among the mixers, in particular, a single-ended mixer has the advantage that it is easy to configure and easy to achieve high-frequency conversion and wide bandwidth.

However, the single-end mixer has a disadvantage that a local oscillator (LO) signal is likely to leak to a radio frequency (RF) signal. LO leakage, which is a leaked signal, has various adverse effects on the radio system. For example, when an LO leakage is input to an amplifier of a transceiver, a signal-to-noise (SN) ratio is deteriorated by a third-order intermodulation wave generated between an RF signal and an LO leak. When the RF signal mixed with the LO leakage is input to the mixer on the reception side, a DC component is generated in a down-converted IF (Intermediate Frequency) signal, which causes a deviation of a bias point of the mixer, leading to deterioration of conversion gain characteristics of the mixer. In addition, when an LO leakage with too high strength is radiated into the air through the antenna, there is also a possibility that it will violate the Radio Law.

For the reasons described above, it is desirable to suppress the LO leakage as much as possible. Conventionally, as a method of suppressing the LO leakage, a method of providing a guard band in an IF signal in a transmitter and connecting a filter to an output of the mixer has been proposed (see Non Patent Literature 1). For example, in the configuration illustrated in FIG. 11, the frequency of the LO signal is multiplied by 18 by a frequency multiplier 100. The mixer 101 mixes the frequency-multiplied LO signal and the IF signal to generate an RF signal.

FIG. 11 illustrates an example of single sideband communication using an upper sideband of both sidebands generated in the mixer 101. The high-pass filter (HPF) 102 suppresses both the lower sideband and the LO leakage caused by the mixing of the LO signal and the IF signal, and prevents a lower sideband and the LO leakage from being radiated into the air through the antenna 103. In FIG. 11, 200 denotes a frequency spectrum of the LO signal before the frequency multiplication, 201 denotes a frequency spectrum of the LO signal after the frequency multiplication, 202 denotes a frequency spectrum of the IF signal, 203 denotes a frequency spectrum of an output signal of the mixer 101, and 204 denotes a frequency spectrum of an output signal of the HPF 102.

In the configuration of FIG. 11, since out-of-band suppression performance of the HPF 102 is low at a high frequency such as the terahertz band, there is a problem that the LO leakage cannot be sufficiently suppressed. For example, even when a waveguide filter having a high Q value in the terahertz band is generally used as the HPF 102, the out-of-band suppression performance remains approximately −30 dB (0.001 times) at a frequency 5 GHz away from the cutoff frequency.

### Citation List

### Non Patent Literature

Non Patent Literature 1: Hiroshi Hamada, et al., “300-GHz,100-Gb/s InP-HEMT wireless transceiver using a 300-GHz fundamental mixer”, 2018 IEEE/MTT-S International Microwave Symposium-IMS, IEEE, 2018

### SUMMARY

### Technical Problem

Embodiments of the present invention have been made to solve the above problems, and an object thereof is to provide a radio communication transceiver capable of improving LO leakage suppression performance more than before.

### Solution to Problem

A radio communication transceiver according to embodiments of the present invention includes a first frequency multiplier configured to multiply a frequency of an LO signal, a mixer configured to mix the LO signal and an IF signal output from the first frequency multiplier to generate an RF signal, a cancel signal generation unit configured to generate a cancel signal to cancel the LO signal, an antenna configured to transmit an RF signal, and a multiplexer configured to output a signal obtained by adding the output signal of the mixer and the cancel signal to the antenna, in which the cancel signal generation unit generates the cancel signal having a same absolute value of strength and an opposite phase at a same frequency with respect to the LO signal input from the mixer to the multiplexer.

### Advantageous Effects

According to embodiments of the present invention, the cancel signal generation unit and the multiplexer are provided, and the cancelation signal having the same absolute value of strength and the opposite phase at the same frequency with respect to the LO signal input from the mixer to the multiplexer is generated, so that the LO signal leaking to the antenna can be suppressed, and the LO signal can be prevented from being radiated into the air through the antenna.

### BRIEF DESCRIPTION OF THE DRAWINGS

FIG. 1 is a block diagram illustrating a configuration of a transmitter of a radio communication transceiver according to a first embodiment of the present invention.

FIG. 2 is a circuit diagram illustrating a configuration example of a mixer according to the first embodiment of the present invention.

FIG. 3 is a diagram illustrating LO leakage suppression performance of the transmitters according to the related art and the first embodiment of the present invention.

FIG. 4 is a block diagram illustrating a configuration of a transmitter of a radio communication transceiver according to a second embodiment of the present invention.

FIG. 5 is a block diagram illustrating a configuration of a transmitter of a radio communication transceiver according to a third embodiment of the present invention.

FIG. 6 is a block diagram illustrating a configuration of a transmitter of a radio communication transceiver according to a fourth embodiment of the present invention.

FIG. 7 is a block diagram illustrating a configuration of a transmitter of a radio communication transceiver according to a fifth embodiment of the present invention.

FIG. 8 is a block diagram illustrating a configuration of a receiver of a radio communication transceiver according to a sixth embodiment of the present invention.

FIG. 9 is a block diagram illustrating a configuration of a transmitter of a radio communication transceiver according to a seventh embodiment of the present invention.

FIG. 10 is a block diagram illustrating a configuration of a transmitter of a radio communication transceiver according to an eighth embodiment of the present invention.

FIG. 11 is a block diagram illustrating a configuration of a transmitter of a conventional radio communication transceiver.

### DETAILED DESCRIPTION OF ILLUSTRATIVE EMBODIMENTS

In embodiments of the present invention, a multiplexer is added to an output of a configuration of a conventional transmitter. It is possible to suppress LO leakage and to prevent LO leakage from being radiated to the air through the antenna by adding an LO cancel signal having the same absolute value of strength and the opposite phase at the same frequency with respect to the LO leakage generated in the mixer by the multiplexer. According to embodiments of the present invention, the LO leakage suppression performance can be improved and the LO leakage can be suppressed even when the frequency of the LO signal is changed, and the flexibility of the system can be improved.

### First Embodiment

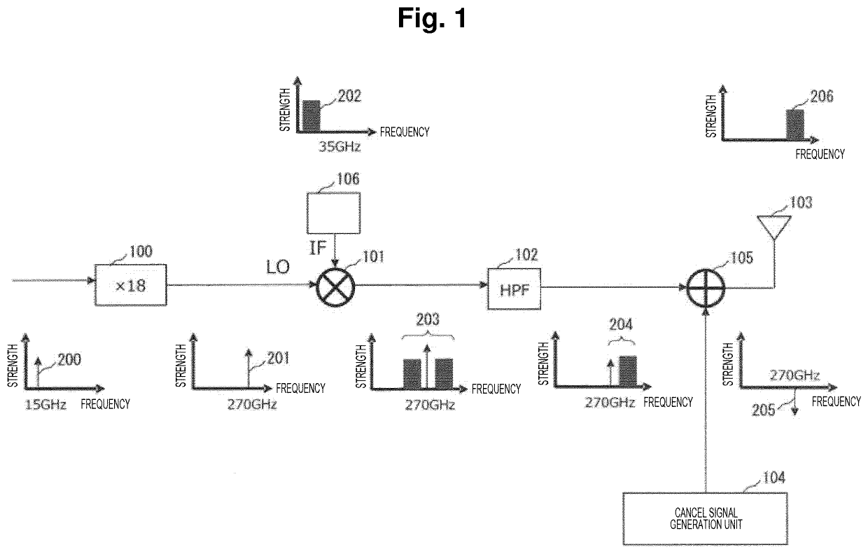

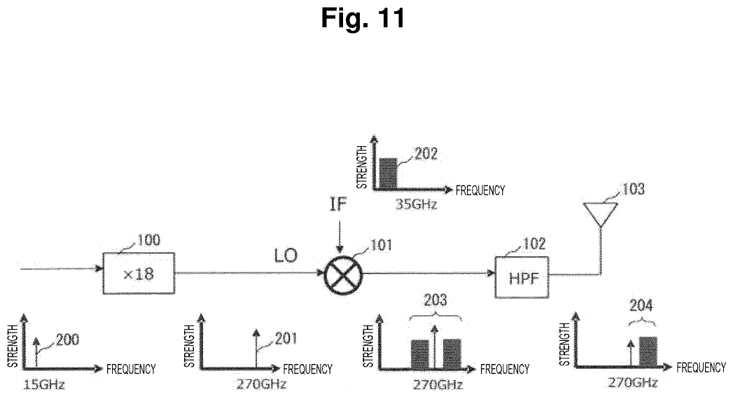

Hereinafter, embodiments of the present invention will be described with reference to the drawings. FIG. 1 is a block diagram illustrating a configuration of a transmitter of a radio communication transceiver according to a first embodiment of the present invention, and the same components as those in FIG. 11 are denoted by the same reference numerals.

The transmitter includes a frequency multiplier 100 that multiplies the frequency of the LO signal by a predetermined multiplication number (18 in the present embodiment), a mixer 101 (multiplier) that mixes the LO signal output from the frequency multiplier 100 and the IF signal to generate an RF signal, an HPF 102 that performs high-frequency filtering on an output signal of the mixer 101 and passes the RF signal of a desired frequency, an antenna 103 that transmits the RF signal, a cancel signal generation unit 104 that generates an LO cancel signal for canceling the LO leakage, a multiplexer 105 (adder) that outputs a signal obtained by adding an output signal of the HPF 102 and the LO cancel signal to the antenna 103, and a modulator 106 that converts a transmission baseband signal into the IF signal.

The frequency spectrum at 200 to 204 in FIG. 1 is as described in FIG. 11. In FIG. 1, 205 denotes a frequency spectrum of the LO cancel signal, and 206 denotes a frequency spectrum of an output signal of the multiplexer 105. In the present embodiment, the frequency of the LO signal before the frequency multiplication is 15 GHz, the multiplication number of the frequency multiplier 100 is 18, the frequency of the LO signal after the frequency multiplication is 270 GHz, and the frequency of the IF signal is 35 GHz.

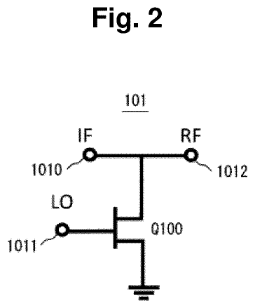

The mixer 101 is a single-end mixer. As illustrated in FIG. 2, the mixer 101 includes a transistor Q100 having a gate terminal connected to an LO signal terminal 1011, a source terminal connected to ground, and a drain terminal connected to an IF signal terminal 1010 and an RF signal terminal 1012. In this circuit, when the IF signal is input to the IF signal terminal 1010 and the LO signal is input to the LO signal terminal 1011, an RF signal is output from the RF signal terminal 1012. Needless to say, the configuration of the mixer 101 is not limited to the configuration of FIG. 2.

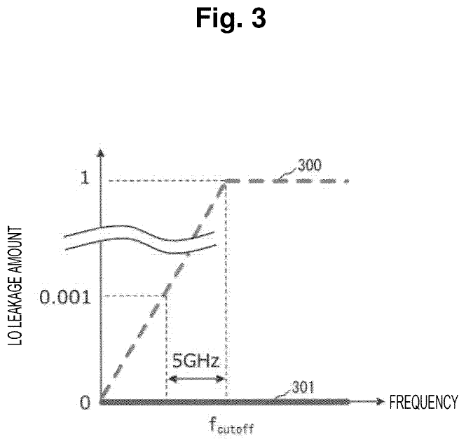

In the present embodiment, as illustrated in FIG. 1, the multiplexer 105 is added to the output of the conventional configuration. FIG. 3 is a diagram illustrating a result of comparison between the LO leakage suppression performance of the conventional transmitter illustrated in FIG. 11 and the LO leakage suppression performance of the present embodiment. In FIG. 3, 300 denotes the LO leakage suppression performance of the conventional transmitter, and 301 denotes the LO leakage suppression performance of the present embodiment. As in the related art, when only the HPF 102 including the waveguide filter is used, the LO leakage amount at a frequency 5 GHz away from the cutoff frequency f_{cutoff} remains 0.001 times as large as the LO leakage amount at a frequency higher than the cutoff frequency f_{cutoff} assumed to be 1. The HPF 102 can remove the lower sideband of the output signal of the mixer 101, but cannot remove the LO leakage.

On the other hand, in the present embodiment, the LO cancel signal having the same absolute value of strength and the opposite phase at the same frequency with respect to the LO leakage input from the HPF 102 to the multiplexer 105 is generated, and the LO cancel signal is added to the output signal of the HPF 102, whereby the LO leakage amount can be set to 0 in principle.

Although the example in which the antenna 103 is connected behind the multiplexer 105 is illustrated in the present embodiment, a power amplifier may be inserted between the multiplexer 105 and the antenna 103 in order to increase transmission power. In the present embodiment, since the LO leakage is suppressed, the amplified RF signal is not distorted by the LO leakage.

### Second Embodiment

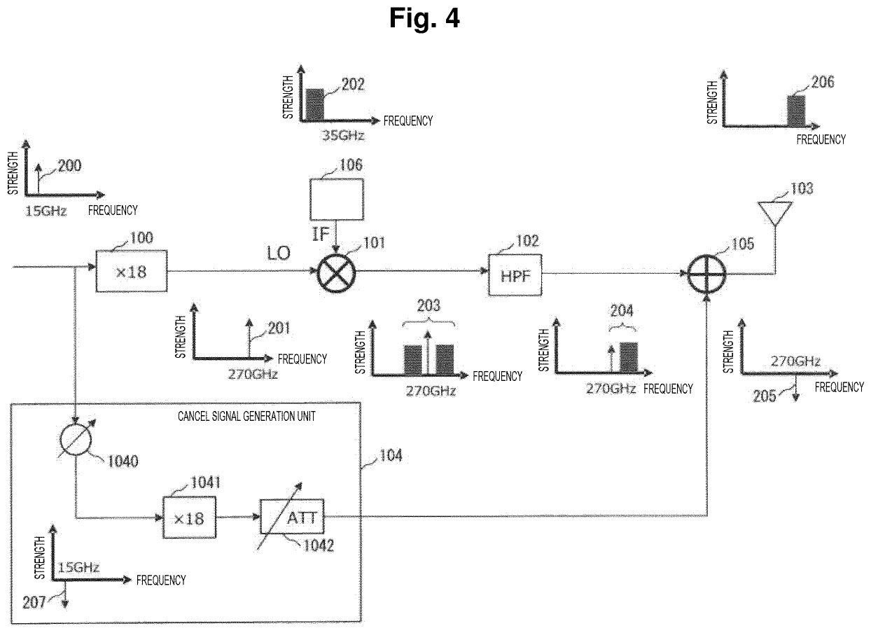

FIG. 4 is a block diagram illustrating a configuration of a transmitter of a radio communication transceiver according to a second embodiment of the present invention, and the same components as those in FIG. 1 are denoted by the same reference numerals. In the present embodiment, a specific example of the cancel signal generation unit 104 of the first embodiment will be described. The cancel signal generation unit 104 includes a variable phase shifter 1040, a frequency multiplier 1041, and a variable attenuator 1042. A frequency spectrum 207 of the output signal of variable phase shifter 1040 is illustrated in FIG. 4.

The variable phase shifter 1040 in the IF band shifts the phase of the same signal as the LO signal input to the frequency multiplier 100 and outputs the signal so that the LO cancel signal output from the cancel signal generation unit 104 has an opposite phase to the LO leakage input from the HPF 102 to the multiplexer 105.

The frequency multiplier 1041 multiplies the frequency of the output signal of the variable phase shifter 1040 by the same multiple (18 in the present embodiment) as the frequency multiplier 100 so that the LO cancel signal output from the cancel signal generation unit 104 has the same frequency as the LO leakage input from the HPF 102 to the multiplexer 105.

The variable attenuator 1042 in the RF band attenuates the output signal of the frequency multiplier 1041 so that the absolute value of the strength of the LO cancel signal output from the cancel signal generation unit 104 is the same as the absolute value of the strength of the LO leakage input from the HPF 102 to the multiplexer 105.

Thus, in the present embodiment, the LO cancel signal can be generated by adjusting the phase shift amount of the variable phase shifter 1040 and the attenuation amount of the variable attenuator 1042.

By disposing the variable phase shifter 1040 in front of the frequency multiplier 1041, a variable phase shifter having a wide range and a low loss in an IF band can be used. A phase shift function can also be implemented by a method in which the variable phase shifter is disposed behind the frequency multiplier 1041, but it is difficult to implement a phase shifter having a wide range and a low loss in the RF band.

The RF band variable attenuator 1042 is disposed behind the frequency multiplier 1041 because it is easy to adjust the strength of the LO cancel signal. The strength of the LO cancel signal can also be adjusted by a method of adding a variable attenuator in the IF band before the frequency multiplier 1041. However, since the frequency multiplier 1041 generally operates in a state where the output is saturated, it is difficult to adjust the output strength with the input strength of the frequency multiplier 1041.

Note that, when the absolute value of the strength of the LO cancel signal and the absolute value of the strength of the LO leakage input to the multiplexer 105 are not the same even if the variable attenuator 1042 is adjusted, a variable attenuator may be inserted between the frequency multiplier 100 and the mixer 101.

### Third Embodiment

In the first and second embodiments, the case of single-sideband communication using an upper sideband has been described, but in the present embodiment, a case of both-sideband communication will be described. In general, in a case where both-sideband communication is performed, it is necessary to use a balanced mixer in order to suppress LO leakage. However, since the balanced mixer has a complicated circuit configuration as compared with the single-end mixer, there is a problem that the band is easily deteriorated.

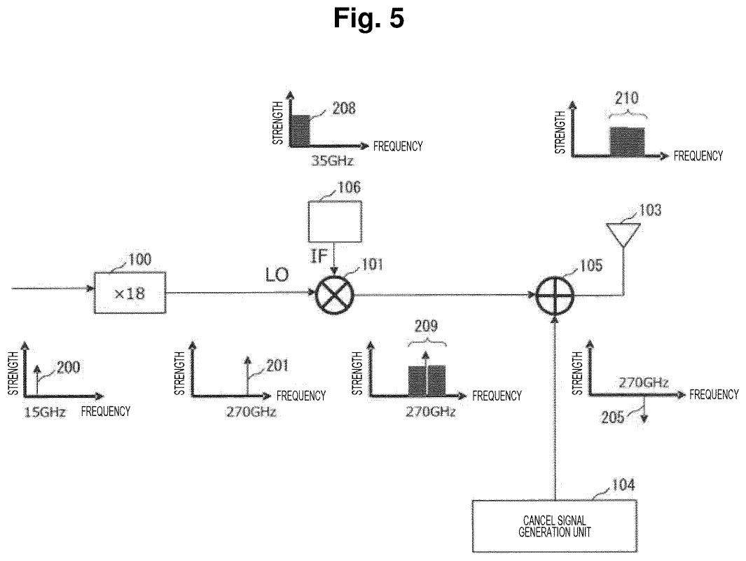

FIG. 5 is a block diagram illustrating a configuration of a transmitter of the radio communication transceiver according to the present embodiment, and the same components as those in FIGS. 1 and 4 are denoted by the same reference numerals. In FIG. 5, 208 denotes a frequency spectrum of the IF signal, 209 denotes a frequency spectrum of the output signal of the mixer 101, and 210 denotes a frequency spectrum of the output signal of the multiplexer 105.

In the present embodiment, the HPF 102 provided in the first and second embodiments is removed, and the output signal of the mixer 101 is directly input to the multiplexer 105. In the present embodiment, it is sufficient if the LO cancel signal having the same absolute value of strength and the opposite phase at the same frequency with respect to the LO leakage input from the mixer 101 to the multiplexer 105 is generated.

In the present embodiment, the both-sideband communication in which the LO leakage is suppressed can be performed using the single-end-type mixer 101 without using the balanced mixer. In the present embodiment, since it is not necessary to provide a guard band in the IF signal, it is possible to fully utilize the band of the modulator that generates the IF signal and to perform higher-speed communication.

### Fourth Embodiment

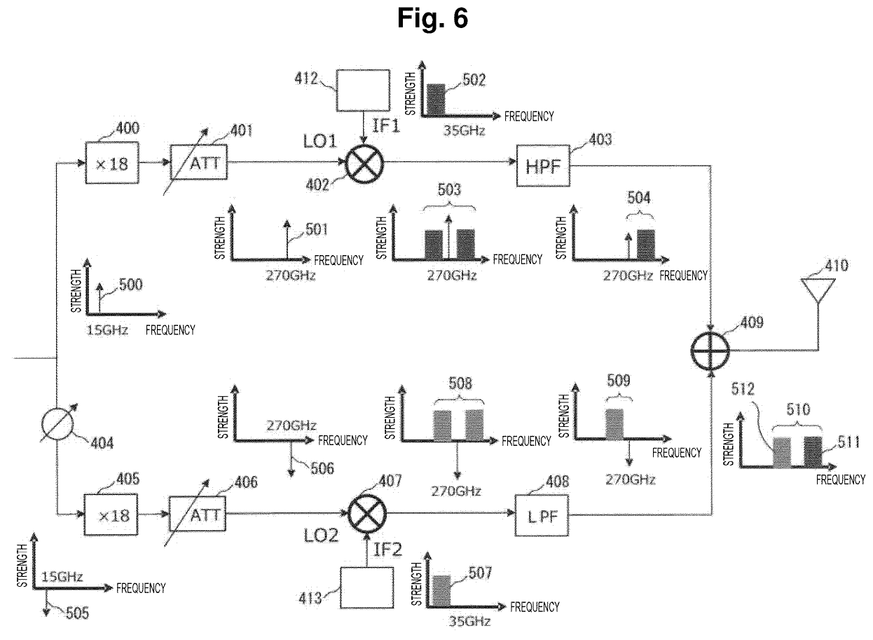

In the present embodiment, a method of suppressing the LO leakage when performing two-channel radio communication will be described. FIG. 6 is a block diagram illustrating a configuration of a transmitter of the radio communication transceiver according to the present embodiment.

The transmitter of the present embodiment includes a frequency multiplier 400 that multiplies the frequency of the LO signal by 18, a variable attenuator 401 that attenuates an output signal of the frequency multiplier 400, a mixer 402 that mixes the LO signal (LO1) output from the variable attenuator 401 and the IF signal (IF1) for channel 1 to generate an RF signal for channel 1, an HPF 403 that high-pass filtering on an output signal of the mixer 402 and passes the RF signal having a frequency for channel 1, a variable phase shifter 404 that shifts the phase of the same signal as the LO signal input to the frequency multiplier 400 and outputs the signal, a frequency multiplier 405 that multiplies the frequency of an output signal of the variable phase shifter 404 by the same multiple (18 in the present embodiment) as the frequency multiplier 400, a variable attenuator 406 that attenuates an output signal of a frequency multiplier 405, a mixer 407 that mixes an LO signal (LO2) output from the variable attenuator 406 and an IF signal (IF2) for channel 2 to generate an RF signal for channel 2, a low-pass filter (LPF) 408 that performs low-pass filtering on an output signal of the mixer 407 and passes the RF signal having a frequency for channel 2, a multiplexer 409 that adds an output signal of the HPF 403 and an output signal of the LPF 408, an antenna 410 that transmits the RF signal output from the multiplexer 409, a modulator 412 that converts a transmission baseband signal for channel 1 into an IF signal (IF1) for channel 1, and a modulator 413 that converts a transmission baseband signal for channel 2 into an IF signal (IF2) for channel 2.

The mixers 402 and 407 are single-end mixers similar to the mixer 101. In FIG. 6, 500 denotes a frequency spectrum of the LO signal before frequency multiplication, 501 denotes a frequency spectrum of the output signal of the variable attenuator 401, 502 denotes a frequency spectrum of the IF signal for the channel 1, 503 denotes a frequency spectrum of the output signal of the mixer 402, and 504 denotes a frequency spectrum of the output signal of the HPF 403. Further, 505 denotes a frequency spectrum of the output signal of the variable phase shifter 404, 506 denotes a frequency spectrum of the output signal of the variable attenuator 406, 507 denotes a frequency spectrum of the IF signal for the channel 2, 508 denotes a frequency spectrum of the output signal of the mixer 407, and 509 denotes a frequency spectrum of the output signal of the LPF 408. Further, 510 denotes a frequency spectrum of the output signal of the multiplexer 409, 511 denotes a frequency spectrum of the RF signal for the channel 1 in the output of the multiplexer 409, and 512 denotes a frequency spectrum of the RF signal for the channel 2.

The HPF 403 can remove the lower sideband of the output signal of the mixer 402, but cannot remove the LO leakage. On the other hand, the LPF 408 can remove an upper sideband of the output signal of the mixer 407, but cannot remove the LO leakage.

The variable phase shifter 404 in the IF band shifts the phase of the same signal as the LO signal input to the frequency multiplier 400 and outputs the signal so that the LO leakage input from the HPF 403 to the multiplexer 409 and the LO leakage input from the LPF 408 to the multiplexer 409 have opposite phases.

The variable attenuators 401 and 406 attenuate the output signals of the frequency multipliers 400 and 405 so that the absolute value of the strength of the LO leakage input from the HPF 403 to the multiplexer 409 is the same as the absolute value of the strength of the LO leakage input from the LPF 408 to the multiplexer 409.

Thus, in the present embodiment, by adjusting the phase shift amount of the variable phase shifter 404 and the attenuation amounts of the variable attenuators 401 and 406, the LO leakage can be prevented from being radiated into the air through the antenna 410, and the LO leakage can be suppressed in the case of performing two-channel radio communication.

### Fifth Embodiment

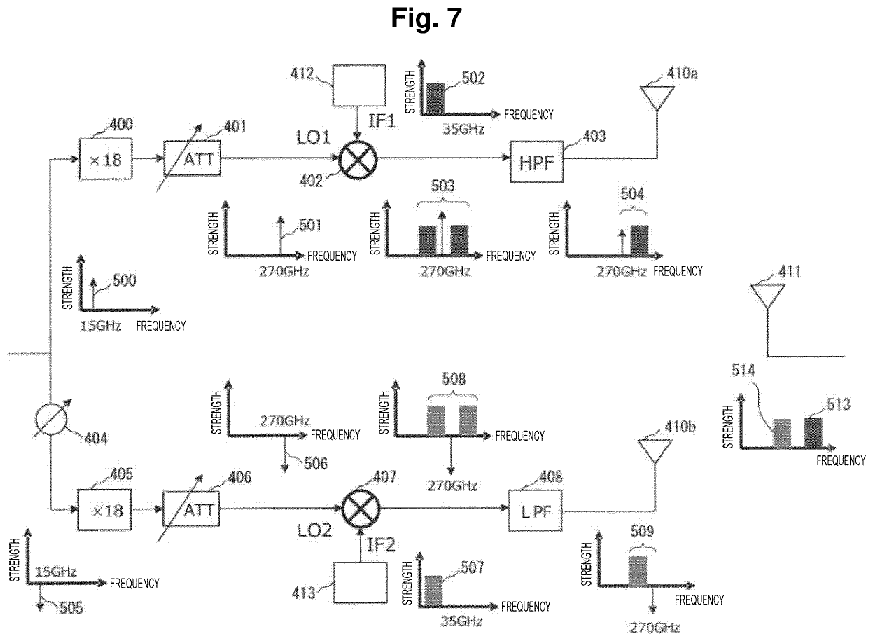

FIG. 7 is a block diagram illustrating a configuration of a transmitter of a radio communication transceiver according to a fifth embodiment of the present invention, and the same components as those in FIG. 6 are denoted by the same reference numerals. In the transmitter of the present embodiment, the multiplexer 409 is removed in the configuration of the fourth embodiment, the output of the HPF 403 is connected to the antenna 410a for the channel 1, and the output of the LPF 408 is connected to the antenna 410b for the channel 2.

The signal transmitted from the antenna 410a to the space and the signal transmitted from the antenna 410b to the space each propagate in the space and are received by the antenna 411 of the receiver. Thus, the signal transmitted from the antenna 410a and the signal transmitted from the antenna 410b are multiplexed by the antenna 411, and the LO leakage is suppressed. In FIG. 7, 513 denotes a frequency spectrum of the RF signal for the channel 1 received by the antenna 411, and 514 denotes a frequency spectrum of the RF signal for the channel 2 received by the antenna 411.

In the present embodiment, since the multiplexer 409 is not used, it is possible to reduce the loss of the RF signal generated in the multiplexer 409.

Note that, unlike the fourth embodiment, in the present embodiment, it is not essential that the LO leakage input from the HPF 403 to the antenna 410a and the LO leakage input from the LPF 408 to the antenna 410b have opposite phases, and it is not essential that the absolute value of the strength of the LO leakage input from the HPF 403 to the antenna 410a and the absolute value of the strength of the LO leakage input from the LPF 408 to the antenna 410b are the same.

In the present embodiment, the phase shift amount of the variable phase shifter 404 only needs to be adjusted so that the LO leakage sent from the antenna 410a and received by the antenna 411 and the LO leakage sent from the antenna 410b and received by the antenna 411 have opposite phases. In addition, the attenuation amounts of the variable attenuators 401 and 406 only need to be adjusted so that the absolute value of the strength of the LO leakage received by the antenna 411 and transmitted from the antenna 410a is identical to the absolute value of the strength of the LO leakage received by the antenna 411 and transmitted from the antenna 410b.

However, in a case where adjustment in the antenna 411 is difficult, the variable phase shifter 404 only needs to shift the phase of the same signal as the LO signal input to the frequency multiplier 400 and output the signal so that the LO leakage input from the HPF 403 to the antenna 410a and the LO leakage input from the LPF 408 to the antenna 410b have opposite phases. In addition, the variable attenuators 401 and 406 only need to attenuate the output signals of the frequency multipliers 400 and 405 so that the absolute value of the strength of the LO leakage input from the HPF 403 to the antenna 410a and the absolute value of the strength of the LO leakage input from the LPF 408 to the antenna 410b are the same.

### Sixth Embodiment

In the first to fifth embodiments, the method of suppressing the LO leakage generated in the mixer on the transmitter side has been described, but the LO leakage may similarly occur in the mixer on the receiver side. In the case of a configuration in which there is no reception amplifier between the antenna of the receiver and the mixer, there is a possibility that the LO leakage generated in the mixer on the reception side is radiated to the air through the antenna.

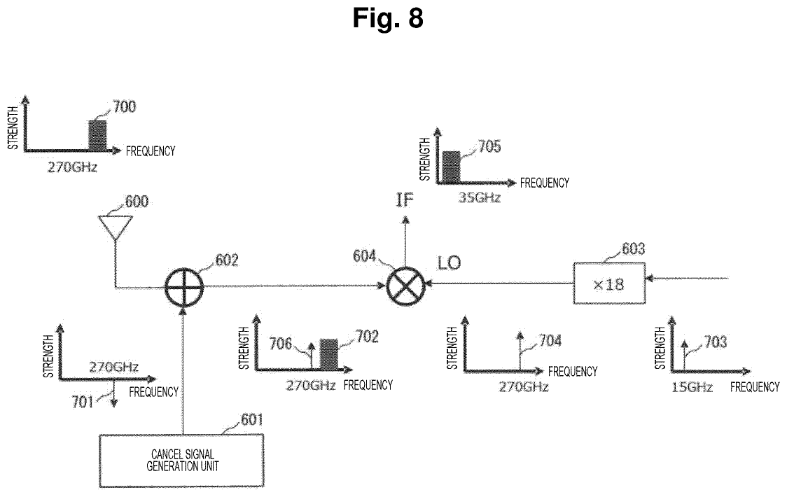

FIG. 8 is a block diagram illustrating a configuration of a receiver of the radio communication transceiver according to the present embodiment. The receiver includes an antenna 600 that receives the RF signal transmitted from the transmitter, a cancel signal generation unit 601 that generates an LO cancel signal, a multiplexer 602 that adds the RF signal received by the antenna 600 and the LO cancel signal output from the cancel signal generation unit 601, a frequency multiplier 603 that multiplies the frequency of the LO signal by 18, and a mixer 604 that mixes an output signal of the multiplexer 602 and an output signal of the frequency multiplier 603 to generate an IF signal.

The mixer 604 is a single-end mixer having a configuration similar to that in FIG. 2. In the case of the mixer 604, when the LO signal is input to the LO signal terminal 1011 and the RF signal is input to the RF signal terminal 1012, the IF signal is output from the IF signal terminal 1010.

In FIG. 8, 700 denotes a frequency spectrum of the RF signal received by the antenna 600, 701 denotes a frequency spectrum of the LO cancel signal, 702 denotes a frequency spectrum of the output signal of the multiplexer 602, 703 denotes a frequency spectrum of the LO signal before the frequency multiplication, 704 denotes a frequency spectrum of the LO signal after the frequency multiplication, and 705 denotes a frequency spectrum of the IF signal. 706 denotes a frequency spectrum of the LO leakage leaking from the mixer 604 to the multiplexer 602 side.

The cancel signal generation unit 601 generates an LO cancel signal having the same absolute value of strength and the opposite phase at the same frequency with respect to the LO leakage leaking from the mixer 604 to the multiplexer 602 side.

In the present embodiment, by inserting the multiplexer 602 between the antenna 600 and the mixer 604 and adding the LO cancel signal to the RF signal received by the antenna 600, it is possible to prevent the LO leakage generated in the mixer 604 from being radiated into the air through the antenna 600.

### Seventh Embodiment

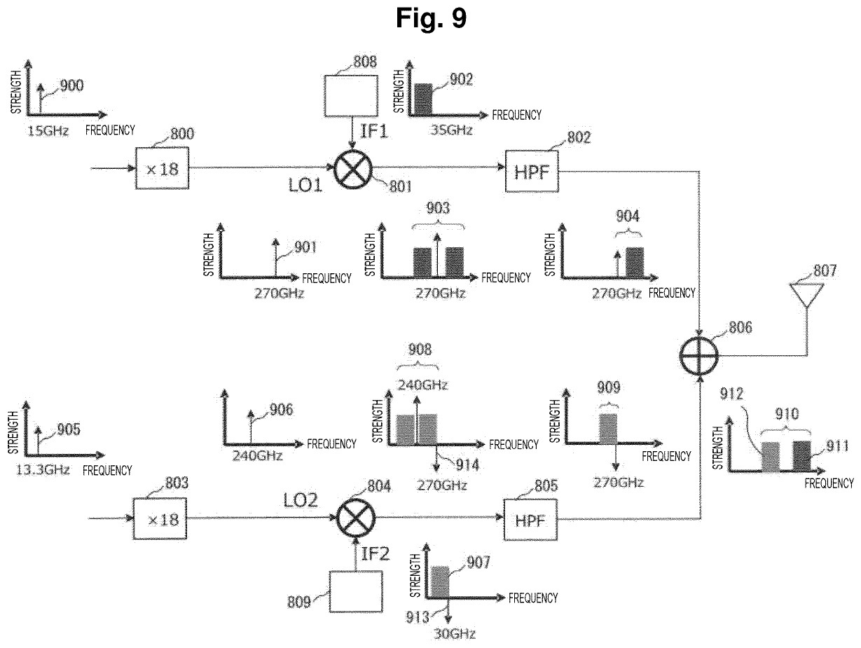

In the present embodiment, a method of suppressing the LO leakage in a case where LO signals having different frequencies are used for two mixers in two-channel radio communication will be described. FIG. 9 is a block diagram illustrating a configuration of a transmitter of the radio communication transceiver according to the present embodiment.

The transmitter of the present embodiment includes a frequency multiplier 800 that multiplies the frequency of the LO signal for the channel 1 by 18, a mixer 801 that mixes the LO signal (LO1) output from the frequency multiplier 800 and the IF signal (IF1) for the channel 1 to generate the RF signal for the channel 1, an HPF 802 that performs high-pass filtering on an output signal of the mixer 801 to pass the RF signal having the frequency for the channel 1, a frequency multiplier 803 that multiplies the frequency of the LO signal for the channel 2 by the same multiple (18 in the present embodiment) as the frequency multiplier 800, a mixer 804 that mixes the LO signal (LO2) output from the frequency multiplier 803 and the IF signal (IF2) for the channel 2 to generate the RF signal for the channel 2, an HPF 805 that performs high-pass filtering on an output signal of a mixer 804 to pass an RF signal having a frequency for the channel 2, a multiplexer 806 that adds the output signal of the HPF 802 and the output signal of the HPF 805, an antenna 807 that transmits the RF signal output from the multiplexer 806, a modulator 808 that converts a transmission baseband signal for the channel 1 into an IF signal (IF1) for the channel 1, and a modulator 809 that converts a transmission baseband signal for the channel 2 into an IF signal (IF2) for the channel 2.

Although the modulators are not described in the transmitters of the first to fifth embodiments, it goes without saying that a modulator that converts a transmission baseband signal into an IF signal is required.

In the present embodiment, a case where the LO signal of 15 GHz for the channel 1 is multiplied by 18 to input the LO signal (LO1) of 270 GHz to the mixer 801, and the LO signal of 13.3 GHz for the channel 2 is multiplied by 18 to input the LO signal (LO2) of 240 GHz to the mixer 804 will be described.

In FIG. 9, 900 denotes a frequency spectrum of the LO signal for the channel 1 before the frequency multiplication, 901 denotes a frequency spectrum of the LO signal for the channel 1 after the frequency multiplication, 902 denotes a frequency spectrum of the IF signal for the channel 1, 903 denotes a frequency spectrum of the output signal of the mixer 801, and 904 denotes a frequency spectrum of the output signal of the HPF 802. Further, 905 denotes a frequency spectrum of the LO signal for the channel 2 before the frequency multiplication, 906 denotes a frequency spectrum of the LO signal for the channel 2 after the frequency multiplication, 907 denotes a frequency spectrum of the IF signal for the channel 2, 908 denotes a frequency spectrum of the output signal of the mixer 804, and 909 denotes a frequency spectrum of the output signal of the HPF 805. Furthermore, 910 denotes a frequency spectrum of the output signal of the multiplexer 806, 911 denotes a frequency spectrum of the RF signal for the channel 1 in the output of the multiplexer 806, and 912 denotes a frequency spectrum of the RF signal for the channel 2. In addition, 913 indicates a component of 30 GHz of the IF signal for the channel 2, and 914 indicates a component of 270 GHz generated from the component of 30 GHz by up-conversion by the mixer 804.

The mixers 801 and 804 are single-end mixers having a configuration similar to that in FIG. 2. The configuration for the channel 1 is similar to that of the transmitter illustrated in FIG. 11.

On the other hand, a component of 30 GHz of the IF signal (IF2) for the channel 2 is used for suppressing the LO leakage. The component of 30 GHz is mixed with the LO signal (LO2) of 240 GHz by the mixer 804, so that the frequency becomes 270 GHz as indicated by 914 in FIG. 9.

In the present embodiment, the frequencies of the RF signals of the channel 1 and the channel 2 are different, and thus the characteristics of the HPF 802 and the HPF 805 are different. The HPF 802 can remove the lower sideband of the output signal of the mixer 801, but cannot remove the LO leakage of 270 GHz. On the other hand, the HPF 805 can remove the lower sideband and the LO leakage of 240 GHz in the output signal of the mixer 804. Since the component of 270 GHz indicated by reference sign 914 in FIG. 9 remains in the output of the HPF 805, the LO leakage input from the HPF 802 to the multiplexer 806 can be suppressed by adding the output signal of the HPF 802 and the output signal of the HPF 805 by the multiplexer 806.

The frequency (30 GHz in the present embodiment), the strength, and the phase of a specific component of the IF signal (IF2) for the channel 2 are set so that a component having the same absolute value of strength and the opposite phase at the same frequency is generated at the output of the HPF 802 with respect to the LO leakage input from the HPF 805 to the multiplexer 806.

Thus, in the present embodiment, the LO leakage can be suppressed without providing the cancel signal generation unit, and the LO leakage can be prevented from being radiated into the air through the antenna 807.

### Eighth Embodiment

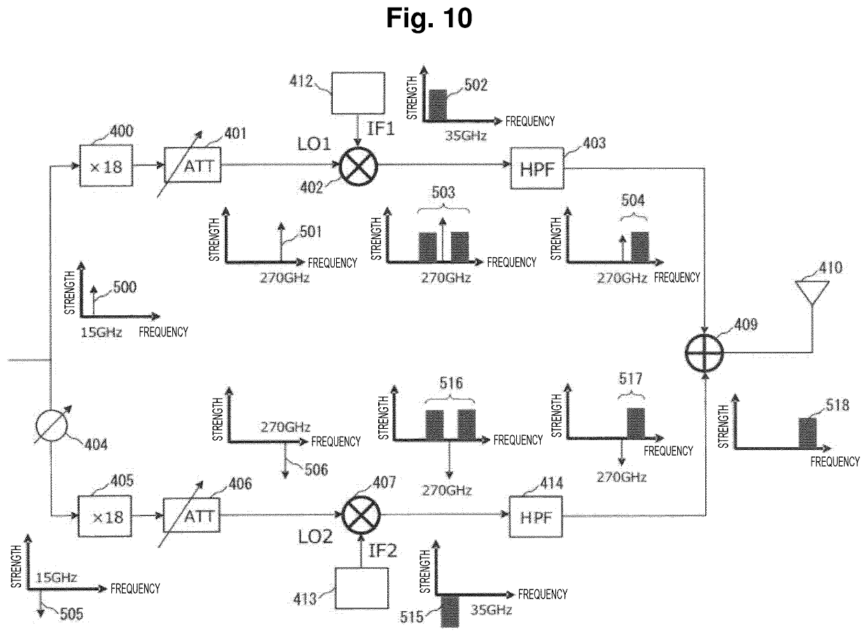

FIG. 10 is a block diagram illustrating a configuration of a transmitter of a radio communication transceiver according to an eighth embodiment of the present invention. The fourth embodiment is configured to perform two-channel radio communication, but the present embodiment is configured to perform one-channel radio communication.

The transmitter of the present embodiment includes a frequency multiplier 400, a variable attenuator 401, a mixer 402, an HPF 403, a variable phase shifter 404, a frequency multiplier 405, a variable attenuator 406, a mixer 407, a multiplexer 409, an antenna 410, modulators 412 and 413, and an HPF 414 that performs high-pass filtering on an output signal of the mixer 407 and passes an RF signal having a frequency for a channel 1.

The mixers 402 and 407 are single-end mixers similar to the mixer 101. In FIG. 10, 500 denotes a frequency spectrum of the LO signal before frequency multiplication, 501 denotes a frequency spectrum of the output signal of the variable attenuator 401, 502 denotes a frequency spectrum of the IF signal for the channel 1 output from the modulator 412, 503 denotes a frequency spectrum of the output signal of the mixer 402, and 504 denotes a frequency spectrum of the output signal of the HPF 403. Further, 505 denotes a frequency spectrum of the output signal of the variable phase shifter 404, 506 denotes a frequency spectrum of the output signal of the variable attenuator 406, 515 denotes a frequency spectrum of the IF signal for the channel 1 output from the modulator 413, 516 denotes a frequency spectrum of the output signal of the mixer 407, 517 denotes a frequency spectrum of the output signal of the HPF 414, and 518 denotes a frequency spectrum of the output signal of the multiplexer 409.

In the present embodiment, the characteristics of the HPFs 403 and 414 are the same. The HPFs 403 and 414 can remove the lower sideband of the output signal of the mixers 402 and 407, but cannot remove the LO leakage.

Meanwhile, the modulators 412 and 413 convert the same transmission baseband signal into an IF signal, but outputs thereof are different. Specifically, the modulator 413 outputs the IF signal (IF2) having the opposite phase to the IF signal (IF1) output from modulator 412. The reason why the IF signal (IF2) is set to the opposite phase is that the RF signal up-converted by the mixer 407 is subjected to in-phase addition by the multiplexer 409.

Thus, in the present embodiment, it is possible to double the strength of the RF signal radiated into the air through the antenna 410 while suppressing the LO leakage.

### Ninth Embodiment

For synchronization of the LO frequency of the transceiver, there is a case where it is necessary to transmit an LO leakage with appropriate strength without completely canceling the LO leakage on the transmission side. Therefore, in the configuration of the radio communication transceiver for suppressing the LO leakage described in the first embodiment, the phase of the LO cancel signal is not completely opposite to the phase of the LO leakage signal, but an appropriate phase difference is given from the opposite phase, so that the LO leakage having an appropriate strength can be transmitted. Alternatively, the absolute value of the strength of the LO cancel signal is not the absolute value of the same strength as that of the LO leakage signal, and the LO leakage having an appropriate strength can be transmitted by making a slight difference in strength.

Note that the frequency of the LO signal, the multiplication number of the frequency multiplier, and the frequency of the IF signal described in the first to ninth embodiments are examples, and are not limited to the numerical values of the first to ninth embodiments.

Some or all of the above-described embodiments may be described as the following supplementary notes, but are not limited to the following.

(Supplementary note 1) A radio communication transceiver according to embodiments of the present invention includes a first frequency multiplier configured to multiply a frequency of an LO signal, a mixer configured to mix the LO signal and an IF signal output from the first frequency multiplier to generate an RF signal, a cancel signal generation unit configured to generate a cancel signal to cancel the LO signal, an antenna configured to transmit an RF signal, and a multiplexer configured to output a signal obtained by adding the output signal of the mixer and the cancel signal to the antenna, in which the cancel signal generation unit generates the cancel signal having a same absolute value of strength and an opposite phase at a same frequency with respect to the LO signal input from the mixer to the multiplexer.

(Supplementary note 2) The radio communication transceiver according to supplementary note 1 further includes a filter provided between the mixer and the multiplexer and configured to filter an output signal of the mixer to pass an RF signal of a desired frequency.

(Supplementary note 3) The radio communication transceiver according to supplementary note 1 or 2, in which the cancel signal generation unit includes a variable phase shifter configured to shift a phase of a same signal as the LO signal input to the first frequency multiplier and output the signal so that the cancel signal has an opposite phase to the LO signal input to the multiplexer, a second frequency multiplier configured to multiply a frequency of an output signal of the variable phase shifter by a same multiple as the first frequency multiplier so that the cancel signal has a same frequency as the LO signal input to the multiplexer, and a variable attenuator configured to attenuate an output signal of the second frequency multiplier so that an absolute value of strength of the cancel signal and an absolute value of strength of the LO signal input to the multiplexer are same.

(Supplementary note 4) A radio communication transceiver according to embodiments of the present invention includes a first frequency multiplier configured to multiply a frequency of an LO signal, a first variable attenuator configured to attenuate an output signal of the first frequency multiplier, a first mixer configured to mix an LO signal output from the first variable attenuator and an IF signal for a first channel to generate an RF signal for the first channel, a first filter configured to filter an output signal of the first mixer to pass the RF signal for the first channel, a variable phase shifter configured to shift a phase of a same signal as the LO signal input to the first frequency multiplier and output the signal, a second frequency multiplier configured to multiply a frequency of an output signal of the variable phase shifter by a same multiple as the first frequency multiplier, a second variable attenuator configured to attenuate an output signal of the second frequency multiplier, a second mixer configured to mix an LO signal output from the second variable attenuator and an IF signal for a second channel to generate an RF signal for the second channel, a second filter configured to filter an output signal of the second mixer to pass the RF signal for the second channel, an antenna configured to transmit an RF signal, and a multiplexer configured to output, to the antenna, a signal obtained by adding an output signal of the first filter and an output signal of the second filter, in which the variable phase shifter shifts the phase of the same signal as the LO signal input to the first frequency multiplier and outputs the signal so that the LO signal input from the first filter to the multiplexer and the LO signal input from the second filter to the multiplexer have opposite phases, and the first and second variable attenuators attenuate the output signals of the first and second frequency multipliers so that an absolute value of strength of the LO signal input from the first filter to the multiplexer is identical to an absolute value of the strength of the LO signal input from the second filter to the multiplexer.

(Supplementary note 5) A radio communication transceiver according to embodiments of the present invention includes a first frequency multiplier configured to multiply a frequency of an LO signal, a first variable attenuator configured to attenuate an output signal of the first frequency multiplier, a first mixer configured to mix an LO signal output from the first variable attenuator and an IF signal for a first channel to generate an RF signal for the first channel, a first antenna configured to transmit an RF signal for a first channel, a first filter configured to filter an output signal of the first mixer and output an RF signal for a first channel to the first antenna, a variable phase shifter configured to shift a phase of a same signal as the LO signal input to the first frequency multiplier and output the signal, a second frequency multiplier configured to multiply a frequency of an output signal of the variable phase shifter by a same multiple as the first frequency multiplier, a second variable attenuator configured to attenuate an output signal of the second frequency multiplier, a second mixer configured to mix an LO signal output from the second variable attenuator and an IF signal for a second channel to generate an RF signal for the second channel, a second antenna configured to transmit the RF signal for the second channel, and a second filter configured to filter an output signal of the second mixer and output the RF signal for the second channel to the second antenna, in which the variable phase shifter shifts the phase of the same signal as the LO signal input to the first frequency multiplier and outputs the signal so that the LO signal transmitted from the first antenna and received by a third antenna on a reception side and the LO signal transmitted from the second antenna and received by the third antenna have opposite phases, and the first and second variable attenuators attenuate output signals of the first and second frequency multipliers so that an absolute value of strength of the LO signal transmitted from the first antenna and received by the third antenna is same as an absolute value of strength of the LO signal transmitted from the second antenna and received by the third antenna.

(Supplementary note 6) A radio communication transceiver according to embodiments of the present invention includes an antenna configured to receive an RF signal sent from a transmitter, a cancel signal generation unit configured to generate a cancel signal for canceling an LO signal output to the antenna, a multiplexer configured to add an RF signal received by the antenna and the cancel signal, a frequency multiplier configured to multiply a frequency of the LO signal, and a mixer configured to mix an output signal of the multiplexer and an output signal of the frequency multiplier to generate an IF signal, in which the cancel signal generation unit generates the cancel signal having a same absolute value of strength and an opposite phase at a same frequency with respect to the LO signal leaking from the mixer to a side of the multiplexer.

(Supplementary note 7) A radio communication transceiver according to embodiments of the present invention includes a first frequency multiplier that multiplies a frequency of an LO signal for a first channel, a first modulator configured to convert a transmission baseband signal for the first channel into an IF signal for the first channel, a first mixer configured to mix an LO signal output from the first frequency multiplier and an IF signal for the first channel to generate an RF signal for the first channel, a first filter configured to filter an output signal of the first mixer to pass the RF signal for the first channel, a second frequency multiplier configured to multiply a frequency of an LO signal for a second channel having a frequency different from a frequency of the LO signal for the first channel by a same multiple as the first frequency multiplier, a second modulator configured to convert a transmission baseband signal for the second channel into an IF signal for the second channel, a second mixer configured to mix the LO signal output from the second frequency multiplier and the IF signal for the second channel to generate an RF signal for a second channel, a second filter configured to filter an output signal of the second mixer to pass the RF signal for the second channel, an antenna configured to transmit an RF signal, and a multiplexer configured to output, to the antenna, a signal obtained by adding an output signal of the first filter and an output signal of the second filter, in which a frequency, a strength, and a phase of a specific component of the IF signal for the second channel are set so that a component having a same absolute value and an opposite phase at a same frequency is generated at an output of the second filter with respect to the LO signal input from the first filter to the multiplexer.

(Supplementary note 8) A radio communication transceiver according to embodiments of the present invention includes a first frequency multiplier configured to multiply a frequency of an LO signal, a first variable attenuator configured to attenuate an output signal of the first frequency multiplier, a first modulator configured to convert a transmission baseband signal into an IF signal, a first mixer configured to mix an LO signal output from the first variable attenuator and an IF signal output from the first modulator to generate an RF signal, a first filter configured to filter an output signal of the first mixer to pass an RF signal, a variable phase shifter configured to shift a phase of a same signal as the LO signal input to the first frequency multiplier and output the signal, a second frequency multiplier configured to multiply a frequency of an output signal of the variable phase shifter by a same multiple as the first frequency multiplier, a second variable attenuator configured to attenuate an output signal of the second frequency multiplier, a second modulator configured to convert the transmission baseband signal into an IF signal, a second mixer configured to mix the LO signal output from the second variable attenuator and the IF signal output from the second modulator to generate an RF signal, a second filter configured to filter an output signal of the second mixer to pass an RF signal, an antenna configured to transmit an RF signal, and a multiplexer configured to output, to the antenna, a signal obtained by adding an output signal of the first filter and an output signal of the second filter, in which the variable phase shifter shifts the phase of the same signal as the LO signal input to the first frequency multiplier and outputs the signal so that the LO signal input from the first filter to the multiplexer and the LO signal input from the second filter to the multiplexer have opposite phases, the first and second variable attenuators attenuate the output signals of the first and second frequency multipliers so that an absolute value of strength of the LO signal input from the first filter to the multiplexer is identical to an absolute value of the strength of the LO signal input from the second filter to the multiplexer, and the second modulator outputs an IF signal having an opposite phase to the IF signal output from the first modulator.

### Industrial Applicability

Embodiments of the present invention can be applied to a technique for suppressing unnecessary signal leakage that adversely affects a wireless system.

### Reference Signs List

100, 400, 405, 603, 800, 803, 1041 Frequency multiplier
101, 402, 407, 604, 801, 804 Mixer
102, 403, 414, 802, 805 High-pass filter
103, 410, 410a, 410b, 411, 600, 807 Antenna
104, 601 Cancel signal generation unit
105, 409, 602, 806 Multiplexer
106, 412, 413, 808, 809 Modulator
404, 1040 Variable phase shifter
401, 406, 1042 Variable attenuator
408 Low pass filter

1-8. (canceled)

9. A radio communication transceiver comprising:
a first frequency multiplier configured to multiply a frequency of a local oscillator (LO) signal;
a mixer configured to mix the LO signal and an intermediate frequency (IF) signal output from the first frequency multiplier to generate a radio frequency (RF) signal;
a cancel signal generator configured to generate a cancel signal to cancel LO leakage generated in the mixer;
an antenna configured to transmit an RF signal; and
a multiplexer configured to output a signal obtained by adding the output signal of the mixer and the cancel signal to the antenna, wherein
the cancel signal generator generates the cancel signal having a same absolute value of strength and an opposite phase at a same frequency with respect to the LO leakage generated in the mixer and input to the multiplexer.

10. The radio communication transceiver according to claim 9, further comprising
a filter provided between the mixer and the multiplexer and configured to filter an output signal of the mixer to pass an RF signal of a desired frequency.

11. The radio communication transceiver according to claim 9, wherein
the cancel signal generator includes
a variable phase shifter configured to shift a phase of a same signal as the LO signal input to the first frequency multiplier and output the signal so that the cancel signal has an opposite phase to the LO leakage input to the multiplexer,
a second frequency multiplier configured to multiply a frequency of an output signal of the variable phase shifter by a same multiple as the first frequency multiplier so that the cancel signal has a same frequency as the LO leakage input to the multiplexer, and
a variable attenuator configured to attenuate an output signal of the second frequency multiplier so that an absolute value of strength of the cancel signal and an absolute value of strength of the LO leakage input to the multiplexer are same.

12. A radio communication transceiver comprising:
a first frequency multiplier configured to multiply a frequency of a local oscillator (LO) signal;
a first variable attenuator configured to attenuate an output signal of the first frequency multiplier;
a first mixer configured to mix an LO signal output from the first variable attenuator and an intermediate frequency (IF) signal for a first channel to generate a radio frequency (RF) signal for the first channel;
a first filter configured to filter an output signal of the first mixer to pass the RF signal for the first channel;
a variable phase shifter configured to shift a phase of a same signal as the LO signal input to the first frequency multiplier and output the signal;
a second frequency multiplier configured to multiply a frequency of an output signal of the variable phase shifter by a same multiple as the first frequency multiplier;
a second variable attenuator configured to attenuate an output signal of the second frequency multiplier;
a second mixer configured to mix an LO signal output from the second variable attenuator and an IF signal for a second channel to generate an RF signal for the second channel;
a second filter configured to filter an output signal of the second mixer to pass the RF signal for the second channel;
an antenna configured to transmit an RF signal; and
a multiplexer configured to output, to the antenna, a signal obtained by adding an output signal of the first filter and an output signal of the second filter, wherein
the variable phase shifter shifts the phase of the same signal as the LO signal input to the first frequency multiplier and outputs the signal so that LO leakage input from the first filter to the multiplexer and LO leakage input from the second filter to the multiplexer have opposite phases, and
the first and second variable attenuators attenuate the output signals of the first and second frequency multipliers so that an absolute value of strength of the LO leakage input from the first filter to the multiplexer is identical to an absolute value of the strength of the LO leakage input from the second filter to the multiplexer.

13. A radio communication transceiver comprising:
a first frequency multiplier configured to multiply a frequency of a local oscillator (LO) signal;
a first variable attenuator configured to attenuate an output signal of the first frequency multiplier;
a first mixer configured to mix an LO signal output from the first variable attenuator and an intermediate frequency (IF) signal for a first channel to generate a radio frequency (RF) signal for the first channel;
a first antenna configured to transmit an RF signal for a first channel;
a first filter configured to filter an output signal of the first mixer and output an RF signal for a first channel to the first antenna;
a variable phase shifter configured to shift a phase of a same signal as the LO signal input to the first frequency multiplier and output the signal;
a second frequency multiplier configured to multiply a frequency of an output signal of the variable phase shifter by a same multiple as the first frequency multiplier;
a second variable attenuator configured to attenuate an output signal of the second frequency multiplier;
a second mixer configured to mix an LO signal output from the second variable attenuator and an IF signal for a second channel to generate an RF signal for the second channel;
a second antenna configured to transmit the RF signal for the second channel; and
a second filter configured to filter an output signal of the second mixer and output the RF signal for the second channel to the second antenna, wherein
the variable phase shifter shifts the phase of the same signal as the LO signal input to the first frequency multiplier and outputs the signal so that LO leakage transmitted from the first antenna and received by a third antenna on a reception side and LO leakage transmitted from the second antenna and received by the third antenna have opposite phases, and
the first and second variable attenuators attenuate output signals of the first and second frequency multipliers so that an absolute value of strength of the LO leakage transmitted from the first antenna and received by the third antenna is same as an absolute value of strength of the LO leakage transmitted from the second antenna and received by the third antenna.

14. The radio communication transceiver according to claim 10, wherein
the cancel signal generator includes
a variable phase shifter configured to shift a phase of a same signal as the LO signal input to the first frequency multiplier and output the signal so that the cancel signal has an opposite phase to the LO leakage input to the multiplexer,
a second frequency multiplier configured to multiply a frequency of an output signal of the variable phase shifter by a same multiple as the first frequency multiplier so that the cancel signal has a same frequency as the LO leakage input to the multiplexer, and
a variable attenuator configured to attenuate an output signal of the second frequency multiplier so that an absolute value of strength of the cancel signal and an absolute value of strength of the LO leakage input to the multiplexer are same.

15. The radio communication transceiver according to claim 12, wherein the first and second filters are high-pass filters configured to remove lower sidebands of the output signals of the first and second mixers respectively.

16. The radio communication transceiver according to claim 12, further comprising:
a first modulator configured to convert a transmission baseband signal for the first channel into the IF signal for the first channel; and
a second modulator configured to convert a transmission baseband signal for the second channel into the IF signal for the second channel.

17. The radio communication transceiver according to claim 12, wherein the first and second frequency multipliers multiply the frequency of their respective input signals by a factor of 18.

18. The radio communication transceiver according to claim 13, wherein the first and second filters are high-pass filters configured to remove lower sidebands of the output signals of the first and second mixers respectively.

19. The radio communication transceiver according to claim 13, wherein the variable phase shifter is configured to adjust the phase shift amount so that the LO leakage sent from the first antenna and received by the third antenna and the LO leakage sent from the second antenna and received by the third antenna have opposite phases.

20. The radio communication transceiver according to claim 13, wherein the first and second variable attenuators are configured to adjust their attenuation amounts so that the absolute value of the strength of the LO leakage received by the third antenna and transmitted from the first antenna is identical to the absolute value of the strength of the LO leakage received by the third antenna and transmitted from the second antenna.
